(19) United States
(12) Patent Application Publication
(10) Pub. No.: US 2014/0096448 A1
(43) Pub. Date: Apr. 10, 2014

(54) AIRTIGHT WINDOW

(71) Applicant: AHC SYSTEMS WINDOWS CO., LTD., Seoul (KR)

(72) Inventor: Chul Woo Joo, Seoul (KR)

(73) Assignee: AHC SYSTEM WINDOWS. CO., LTD., Seoul (KR)

(21) Appl. No.: 14/008,066

(22) PCT Filed: Mar. 15, 2012
(86) PCT No.: PCT/KR2012/001861

§ 371 Date: Nov. 4, 2013

(30) Foreign Application Priority Data
Mar. 18, 2011 (KR) 10-2011-0024528
Apr. 27, 2011 (KR) 10-2011-0039548

(51) Int. Cl. E06B 7/16; E06B 3/44

(52) U.S. Cl. CPC E06B 7/16; E06B 3/44
USPC 49/306; 49/490.1; 49/407

(57) ABSTRACT

Disclosed is an airtight window, which can provide a space for enabling the window to be tilted during the fitting thereof into a window frame, and which cuts off the communication between an indoor area and an outdoor area so as to increase thermal insulation and prevent noise when installed. An upper frame of a window frame has a square C-shape with an open bottom, and has an installation end tightly contacting an installation part of a building and bent ends which extend downwardly from both ends of the installation end and which are bent inwardly so as to face each other. A movable frame of the window frame also has a square C-shape with an open bottom, and both ends thereof are formed into stopper ends so as to be disposed on and caught at the bent ends of the upper frame.

### CROSS-REFERENCE TO RELATED APPLICATIONS

This application is a National Stage of International Application No. PCT/KR2012/001861 filed Mar. 15, 2012, claiming priority based on Korean Patent Application Nos. 10-2011-0024528 filed Mar. 18, 2011, and 10-2011-0039548 filed Apr. 27, 2011, the contents of all of which are incorporated herein by reference in their entirety.

### TECHNICAL FIELD

The present invention relates to an airtight window which is opened and closed in a sliding manner, and more particularly, to an airtight window capable of increasing thermal insulation and preventing noise by securing a space for inserting a window into a window frame in a tilted manner and blocking a flow between an indoor area and an outdoor area when the window is installed.

### BACKGROUND ART

Generally, slide fittings, which have a natural lighting function, a function of enabling a resident to observe an outdoor area in an indoor area, and a ventilation function, are installed in various buildings such as townhouses and apartments.

Such slide fittings, which connect an outdoor area with an indoor area, should be able to allow a resident to enjoy fresh air and sunlight at the indoor area when opening the windows, and protect the resident from the external noise, bad air, a torrential rain, cold wind, hot weather, and strong wind when the windows are closed. That is, in the slide fittings, sound proofing, airproofing, waterproofing, and thermal insulation are very important.

The conventional slide fittings include window frames which includes upper and lower horizontal window frames and right and left vertical window frames including rails, and are fixed on the wall, and upper and lower horizontal window sashes and right and left vertical window frames including rail grooves, which are installed at the window frame in a manner that may be horizontally opened and closed.

The slide fittings may further include mohairs which are installed at rail grooves.

In the slide fittings, rail grooves of the window are respectively inserted into the rails of the window frames, and the mohairs installed at the rail grooves are closely attached to the front side and the rear side of the rails so as to provide soundproofing effects and windshield effects.

However, the conventional sliding fittings include a window sash 7 which is installed by upper, lower, left, and right frames 3, 4, 5, and 6, including a rail 2, in which a window 1 including a window frame 1a, which is opened and closed in a sliding manner, is coupled and moved, as illustrated in FIG. 1.

In the conventional slide fittings, the window sash 7 is constructed, and when the window 1 is installed, the upper end of the window 1 is inserted into the inner side of the upper frame 3 of the window sash 7 so that the upper end of the window 1 is lifted up to the upper part of the lower frame 4.

However, according to the conventional slide fittings, in order to install the window at the window sash, the length of the inner side of the upper frame should be long, and thus if the window is installed and is disposed on the lower frame, the gap between the upper end of the window and the upper frame gets large, thereby lowering thermal insulation and failing to block noise.

### DISCLOSURE

### Technical Problem

The present invention has been designed in consideration of the problems of the conventional art, and an object of the present invention is to provide an upper frame which allows easy installation of the window by installing a movable frame which vertically slides at the inside of the upper frame so that the upper end of the window may be inserted into the inside of the frame which is positioned at the upper part so that the window may be disposed on the lower frame when installing the window at the window sash.

Further, another object of the present invention is to increase thermal insulation and block noise by closely attaching a movable frame, which is installed inside the upper frame, on the upper end of the window by the self-gravity, after installing the window at the window sash.

Further, another object of the present invention is to further increase thermal insulation and block noise by closely attaching a movable frame on the upper end of the window by pushing down the movable frame by elastic force by installing an elastic unit between the upper frame and the movable frame.

Further, another object of the present invention is to increase general usability as a general upper frame may be coupled with the movable frame using a shaft-screw and a nut.

### Technical Solution

In order to solve the above problem, the present invention provides an air shield window: an upper frame of a window sash which is installed by using a square frame of upper, lower, left, and right frames where a plurality of rails are formed where a window having a window frame, which is opened and closed in a sliding manner, is moved, wherein the upper frame has a square C-shape with an open bottom, and has an installation end tightly contacting an installation part of a building and bent ends which extend downwardly from both ends of the installation end and which are bent inwardly so as to face each other, wherein stopper ends, which are disposed on the bent ends of the upper frame, are formed at both ends, and a plurality of movable frames of a square C-shape with an open bottom, which are composed of a plurality of rails, are formed on the lower part of the body end, wherein, when installing the window after connecting left and right frames, which are connected to the lower frame, to both sides of the upper frame by disposing the stopper end at the bent end by inserting the movable frame into the inner side of the upper frame, the upper end of the window is pushed up to the lower frame while securing a margin space for installing the window at a window sash, and wherein, if the window is installed, the movable frame is moved down by the self-gravity to block a flow between an indoor area and an outdoor area.

### Advantageous Effects

According to the present invention, installation of a window becomes easy by installing a movable frame which vertically slides at the inside of the upper frame so that the upper end of the window may be inserted into the inside of the frame which is positioned at the upper part so that the window may be disposed on the lower frame when installing the window at the window sash.

Further, according to the present invention, thermal insulation and block noise may be increased by closely attaching a movable frame, which is installed inside the upper frame, on the upper end of the window by the self-gravity, after installing the window at the window sash.

Further, according to the present invention, thermal insulation may be further increased and noise may be further blocked by closely attaching a movable frame on the upper end of the window by pushing down the movable frame by elastic force by installing an elastic unit between the upper frame and the movable frame.

Further, according to the present invention, general usability may be increased as a general upper frame may be coupled with the movable frame using a shaft-screw and a nut.

### DESCRIPTION OF DRAWINGS

FIG. 1 is a flowchart illustrating a method of installing a conventional slide window at a window frame.

FIG. 2 is a front view showing a window having a window frame, which has been installed at a window sash.

FIG. 3 is a cross-sectional view showing an air shield window where a window having a window frame is installed according to line A-A of FIG. 2.

FIG. 4 illustrates a vertical movement of a movable frame which is installed inside the upper frame where a window having a window frame is installed.

FIG. 5 is a cross-sectional view of a state where an elastic unit is installed in a movable frame which is install inside the upper frame where a window having a window frame is installed.

FIG. 6 is a cross-sectional view of operation of an elastic unit according to a vertical movement of a movable frame which is installed inside the upper frame where a window having a window frame is installed.

FIG. 7 is a cross-sectional view showing an order in which a window having a window frame is installed at a window sash, and an operation of an elastic unit according to a vertical movement of a movable frame which is installed inside the upper frame.

FIG. 8 is a front view showing a window without a window frame, which has been installed at a window sash.

FIG. 9 is a cross-sectional view showing an air shield window where a window without a window frame is installed according to line B-B of FIG. 2.

FIG. 10 illustrates a vertical movement of a movable frame which is installed inside an upper frame where a window without a window frame is installed.

FIG. 11 is a cross-sectional view of a state where an elastic unit is installed in a movable frame which is installed inside an upper frame where a window without a window frame is installed.

FIG. 12 is a cross-sectional view showing an operation of an elastic unit according to a vertical movement of a movable frame which is installed inside an upper frame where a window without a window frame is installed.

FIG. 13 is a cross-sectional view showing an order in which a window without a window frame is installed in a window sash, and operation of an elastic unit according to a vertical movement of a movable frame which is installed inside an upper frame.

FIG. 14 shows an example of an elastic unit.

FIG. 15A is a cross-sectional view showing some embodiments of an elastic unit which is used in various forms of upper frames and movable frames.

FIG. 15B is a cross-sectional view showing various forms of upper frames and movable frames.

FIG. 16 is a cross-sectional view showing an embodiment which is not directly connected and is connected using a connection unit.

FIG. 17 shows an operation when a window is installed in FIG. 16.

FIG. 18 is a cross-sectional view illustrating another example of an elastic unit.

FIG. 19 shows an operation when a window is installed in FIG. 18.

FIG. 20 is a cross-sectional view showing various forms of upper frames and movable frames connected by an elastic unit.

FIG. 21 is a cross-sectional view showing a vertical movement of a movable frame, where one rail is formed, on an upper frame.

FIG. 22 is a cross-sectional view showing another form of upper frame to which a movable frame has been applied.

FIG. 23 is a cross-sectional view showing a configuration where a movable frame including a rail groove is set to be moved on an upper frame.

FIG. 24 is a cross-sectional view showing application of another form of movable frame.

FIG. 25 illustrates an operation where another form of movable frame has been applied to another form of upper frame.

FIG. 26 is a cross-sectional diagram to which another form of movable frame has been applied to another form of upper frame.

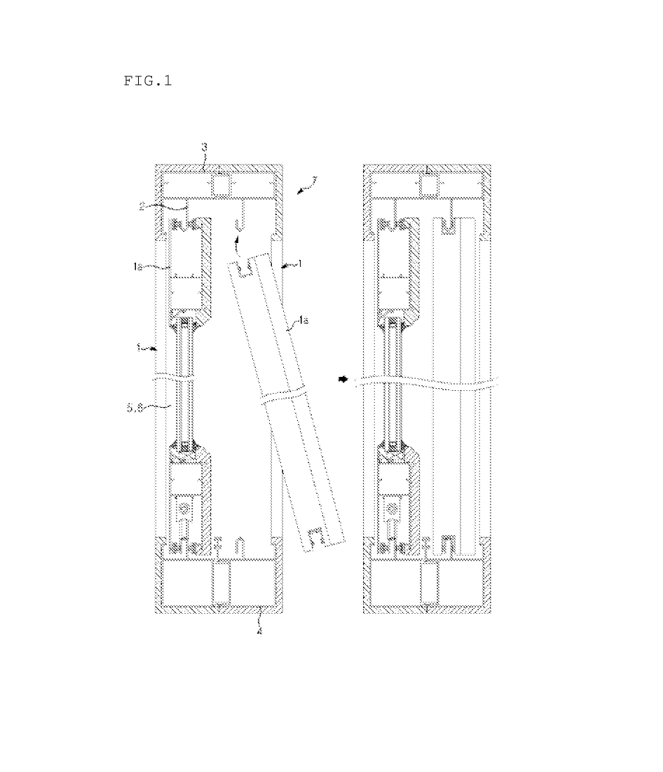

<Brief Description of Symbols in the Drawings>

| | |
|---|---|
| 10: window | |
| 10a: external window | 10b: internal window |
| 11: window frame | |
| 11a: rail groove | 20: rail |
| 30: upper frame | 31: installation end |
| 32: bent end | 32a: extended end |
| 33: upper hole | 34: middle end |
| 34a: penetration hole | |
| 35: fixed frame | 35a: fixed stopping part |
| 40: lower frame | 50: left frame |
| 60: right frame | 70: window frame |
| 80: movable frame | 80a: connection end |
| 80b: upper stopper end | 80c: lower stopper end |
| 81: stopper end | |
| 82: body end | 84: division end |
| 85: guide groove | 86: movable hole |
| 87: shaft-screw | 88: nut |
| 90: elastic unit | |
| 91: support end | |
| 95: sealing part | |
| 100: fitting frame | |
| 200: building | 201: installation part |

### BEST MODE

The present invention relates to an airtight window capable of increasing thermal insulation and preventing noise by securing a space for inserting a window into a window frame in a tilted manner and blocking a flow between an indoor area and an outdoor area when the window is installed.

### Detailed Description of Exemplary Embodiments

Hereinafter, embodiments of the present invention will be described with reference to the attached drawings.

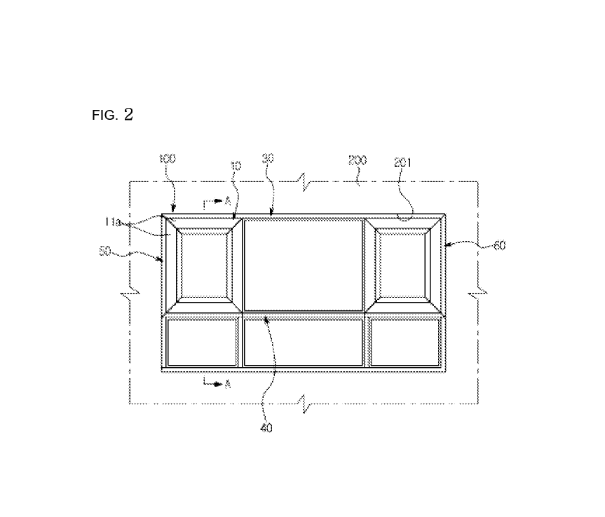

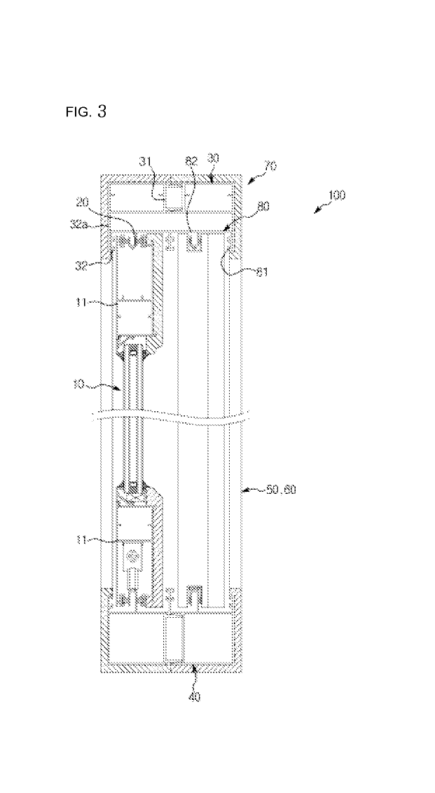

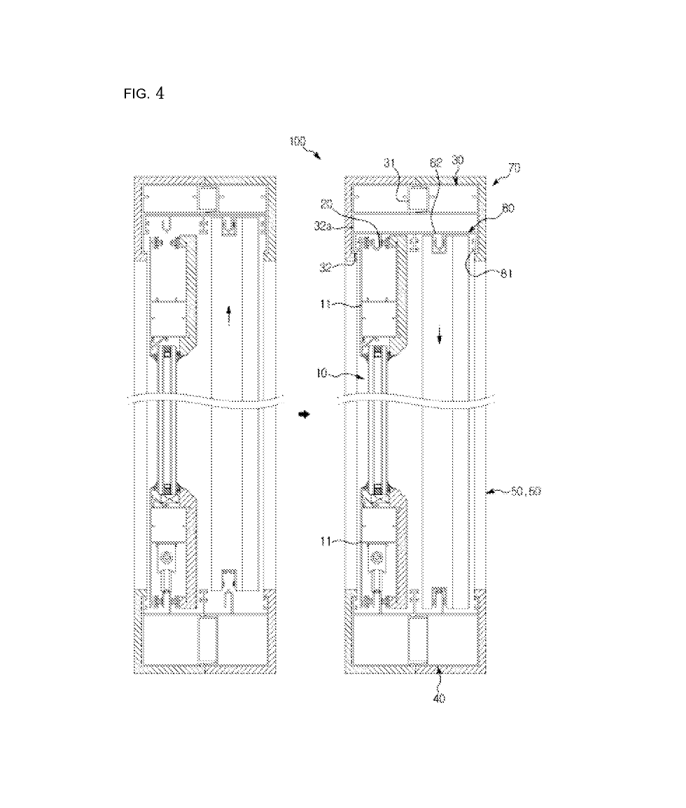

As illustrated in FIGS. 2 to 4, an air shield window of the present invention includes an upper frame 30 of a window sash 70 which is installed by using a square frame of upper, lower, left, and right frames 30, 40, 50 and 60 where a rail 20 is formed where a window 10 having a window frame, which is opened and closed in a sliding manner, is moved.

First, in the present specification, two types of windows 10 will be described. One is a window 10 having a window frame 11, and the other is a window 10 without a window frame.

1. A Window 10 Having a Window Frame 11, and an Upper Frame 30

First, the upper frame 30 has a square C-shape with an open bottom, and has an installation end 31 tightly contacting an installation part 201 of a building 200 and bent ends 32 which extend downwardly from both ends of the installation end and which are bent inwardly so as to face each other.

At this time, the bent ends 32 are formed at lower ends of the extended ends 32a which are integrally extended in a lower direction of the lower surface of both ends of installation end.

Further, stopper ends 81, which are disposed on the bent ends 32 of the upper frame 30, are formed at both ends, and a movable frame 80 of a square C-shape with an open bottom, which is composed of a plurality of rails 20, is formed on the lower part of the body end 82.

Here, in the movable frame 80, the length of the horizontal width is formed smaller than the distance of the extended end 32a of the upper frame 30 in a state that is cross-sectioned to be perpendicular to the lengthy direction so that the movable frame 80 may be slid in a vertical direction inside the upper frame.

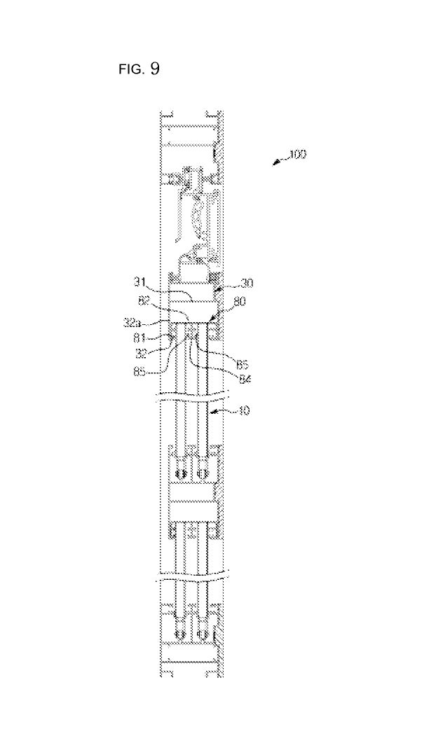

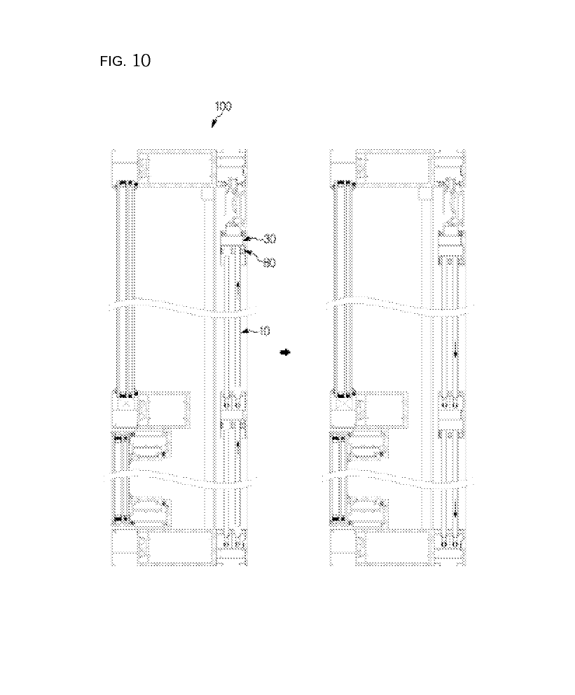

2. A Window 10 without a Window Frame 11 and an Upper Frame 30 as Shown in FIGS. 8 to 10

The window 10 includes an upper frame 30 of a window sash 70 which is installed by using a square frame of upper, lower, left, and right frames 30, 40, 50 and 60 where a window 10 having a window frame, which is opened and closed in a sliding manner, is moved.

First, the upper frame 30 has a square C-shape with an open bottom, and has an installation end 31 tightly contacting an installation part 201 of a building 200 and bent ends 32 which extend downwardly from both ends of the installation end and which are bent inwardly so as to face each other.

At this time, the bent ends 32 are formed at lower ends of the extended ends 32a which are integrally extended in a lower direction of the lower surface of both ends of installation end.

Further, stopper ends 81, which are disposed on the bent ends 32 of the upper frame 30, are formed at both ends.

The division ends 84 are formed under the central part of the body ends 82 which connect the stopper ends 81, and the movable frame 80 is formed in a square C-shape with an open bottom, and is composed of a plurality of guide grooves 85 between the stopper ends 81 and the division ends 84.

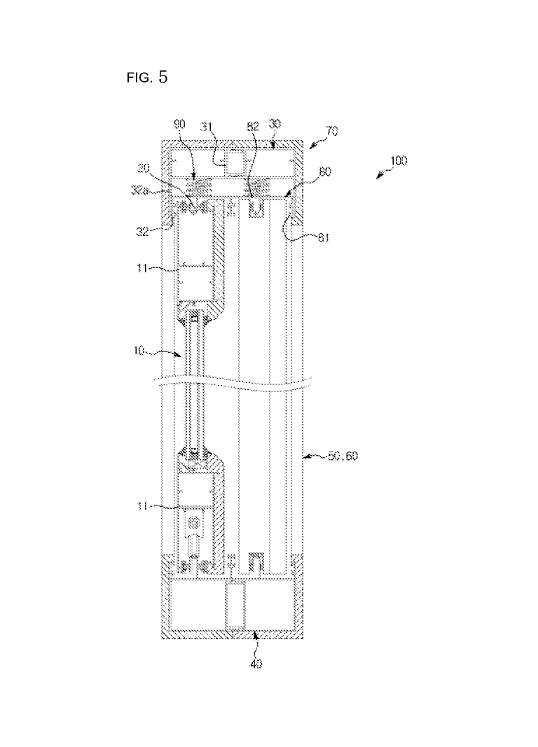

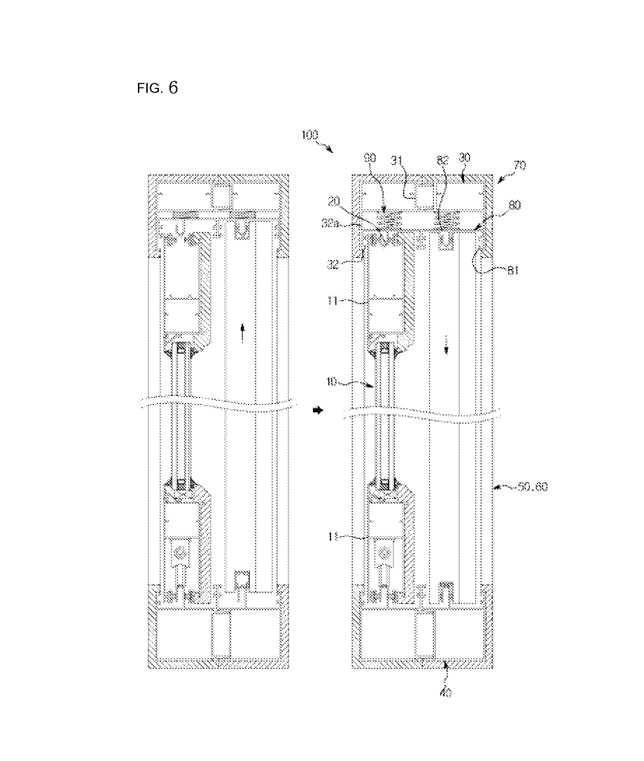

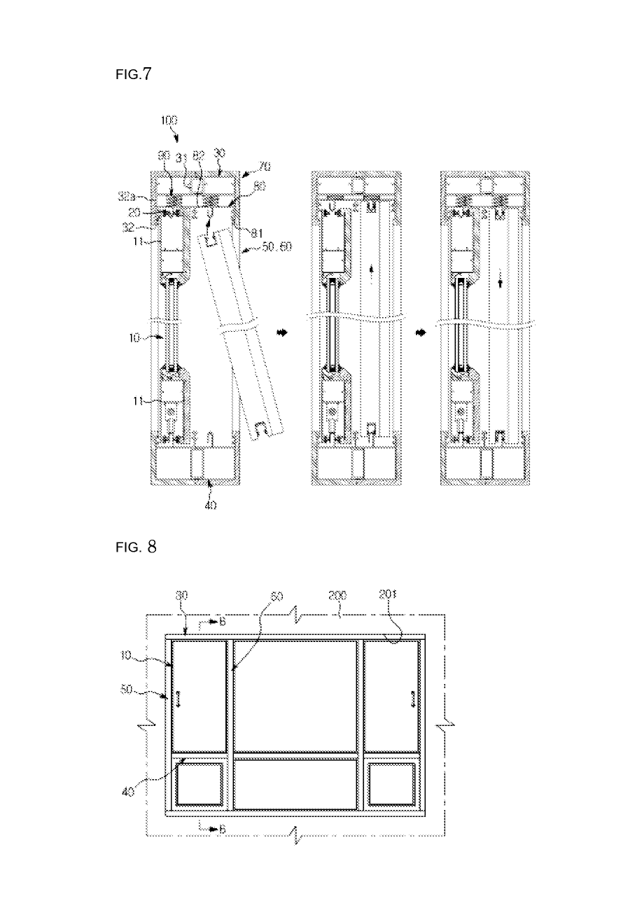

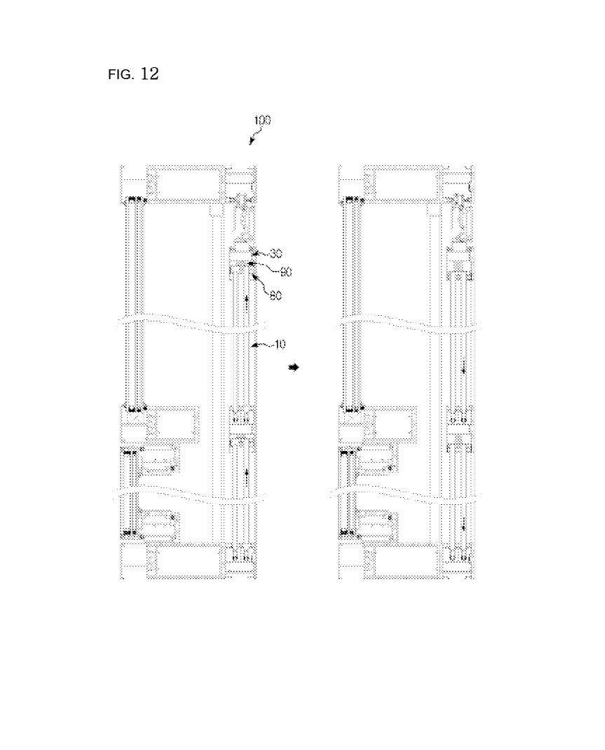

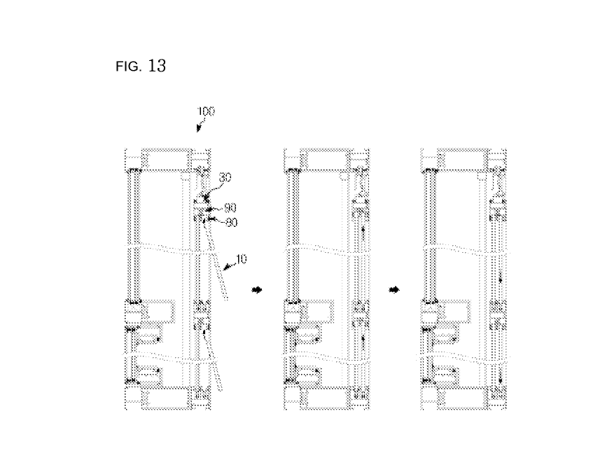

As illustrated in FIGS. 5 to 7 and 11 to 13, an elastic unit 90 may be inserted into a space between the upper frame 30 and the movable frame 80 commonly at the upper frame 30 where the window 10 is installed according to whether there is a window frame 11.

The elastic unit 90 is configured to be pressured by the movable frame 80, which is supported on the upper frame and is pushed up when the window 10 installed, and then to return the movable frame 80 to the lower part by the elastic force when the installation of the window 10 is completed.

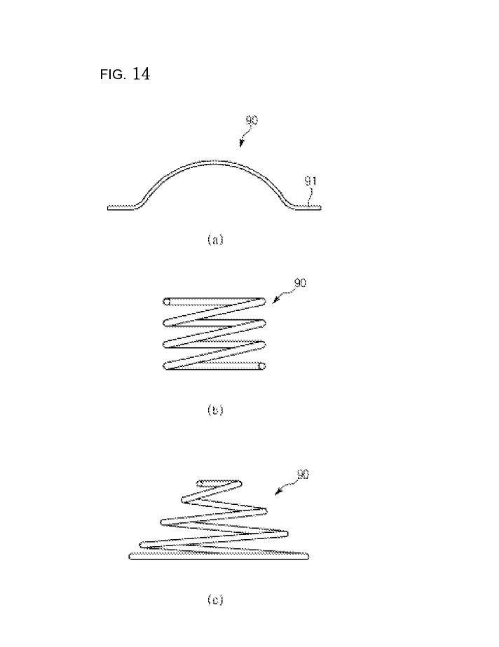

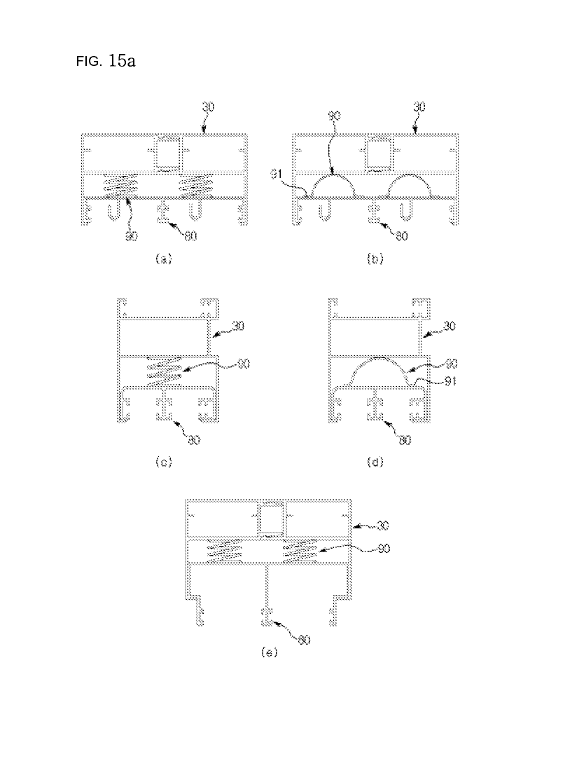

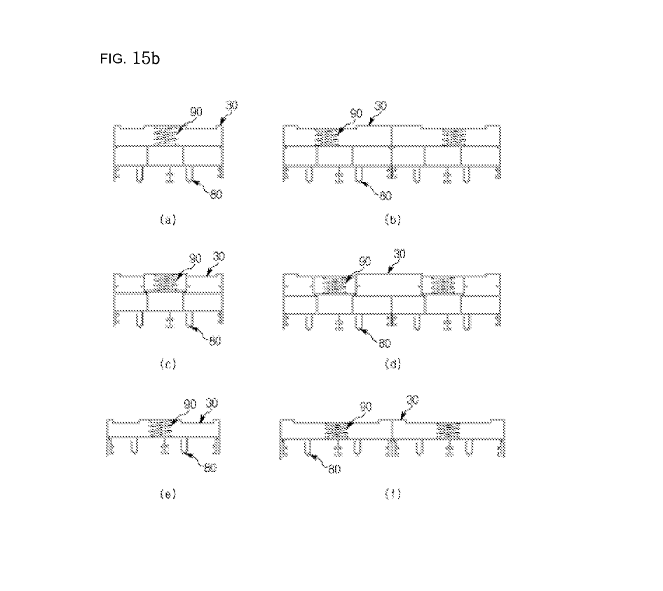

As illustrated in FIGS. 14 and 15A, the elastic unit 90 is semi-cylindrical, and both ends are freely supported on the upper frame or one end is fixed at the upper frame 30.

Here, the elastic unit 90 is semi-cylindrical, and both ends are flatly formed so that the support end 91 capable of supporting the upper frame 30 and the movable frame 80 is integrally formed (see FIG. 14A).

Further, as another example, the elastic unit 90 is formed of a coil spring (see FIG. 14B) having the same diameter at both ends or is formed of a conic coil spring (see FIG. 14C).

Further, the elastic unit 90 may be formed as a coil spring, and one end or both ends may be fixed at the upper frame 30 or the movable frame 80 to prevent movement of the elastic unit 90.

As illustrated in FIG. 15, the support end 91 may be maintained by the free end without fixing at the upper frame 30 or the movable frame 80, or only one end may be fixed at the upper frame 30 or the movable frame 80 so that the other end may be pushed to apply pressure at the time of pressure application.

At this time, the elastic units 90 may be disposed at regular intervals along the lengthy direction of the movable frame or in several lines, and in the case of the elastic plate, the fitting frame 100 is provided to be used long.

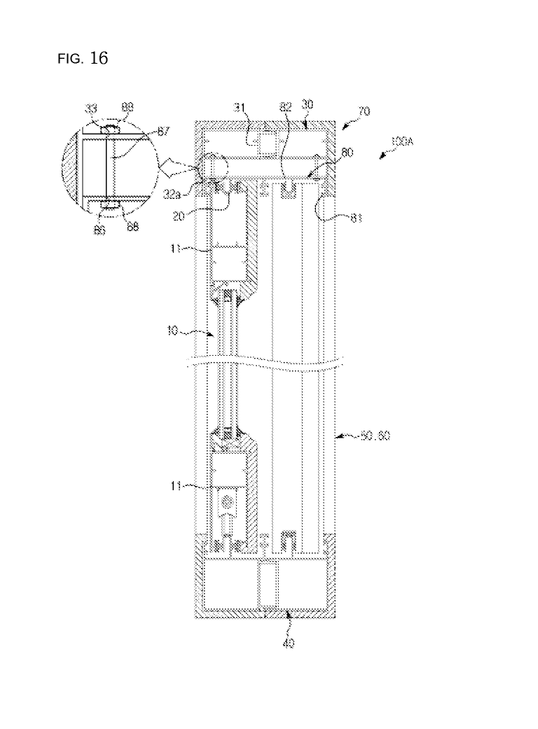

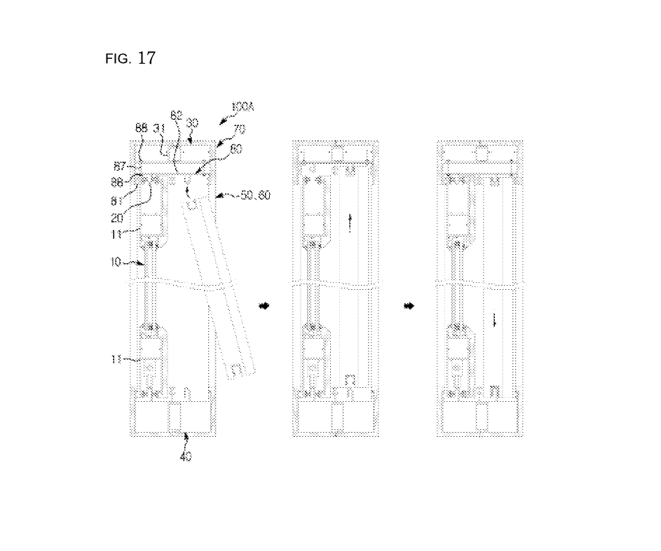

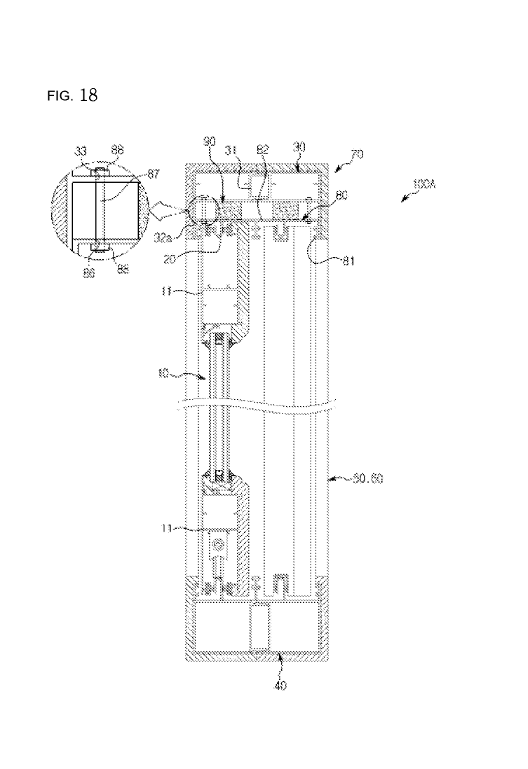

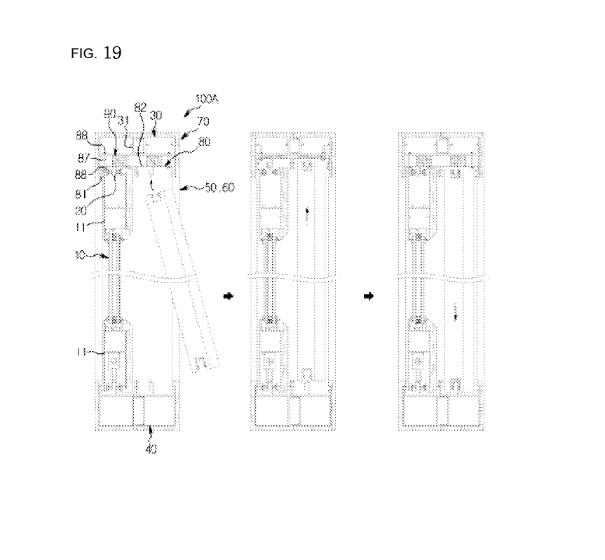

As another example, as illustrated in FIGS. 16 to 19, the movable frame 80 is disposed on the upper frame 30, and is connected by the shaft-screw 87 and the nut 88.

Here, the upper frame 30 forms an upper hole 33 at both ends of the installation end 31 which contacts the installation unit 201 of the building 200 in a square C-shape with an open bottom.

Further, the upper frame 20 is closely attached to the lower part of the installation end 31, and the movable hole 86 penetrates the body end 82 on the same line as that of the upper hole 33.

Further, the movable frame 80 in a square C-shape with an open bottom, which is formed of a plurality of rails 20, is formed on the lower surface of the body end 82.

Further, the nuts 88 are coupled with the shaft-screws 87 whose ends respectively penetrate the upper hole 33 of the upper frame 30 and the movable hole 86 of the movable frame 80.

At this time, the upper frame 30 and the movable frame 80 are formed in a lengthy form, and the upper hole 33 and the movable hole 86 are formed at both ends so that the nuts 88 may be coupled to both ends of the shaft-screws 87 which are exposed through the upper hole 33 and the movable hole 86 using a hand or a coupling tool.

Further, the shaft-screws 87 are cylindrical and several spiral ends may be preferably formed at both ends, and the shaft-screws 87 may be formed such that a head such as a nail and a rivet may be formed at one end, and several spiral ends may be formed at the other end.

Further, the elastic unit 90 is inserted into a space between the upper frame 30 and the movable frame 80.

At this time, the elastic unit 90 is configured to be pressured by the movable frame 80, which is supported on the upper frame and is pushed up when the window 10 installed, and then to return the movable frame 80 to the lower part by the elastic force when the installation of the window 10 is completed.

The elastic unit 90 configures a fitting frame 100A by forming a cushion member with elasticity using sponge.

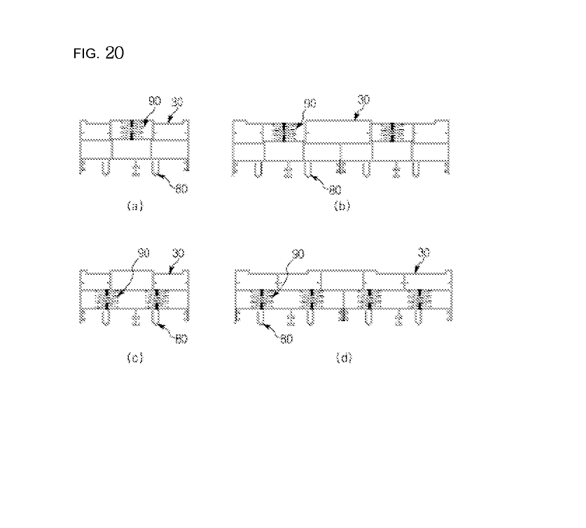

As illustrated in FIG. 20, the elastic unit 90, which is inserted in a space between the upper frame 30 and the movable frame 80, is formed as a coil spring, the upper end of the spring is attached on the upper surface of the upper frame, and the lower end of the spring is formed on the roof surface of the movable frame 80.

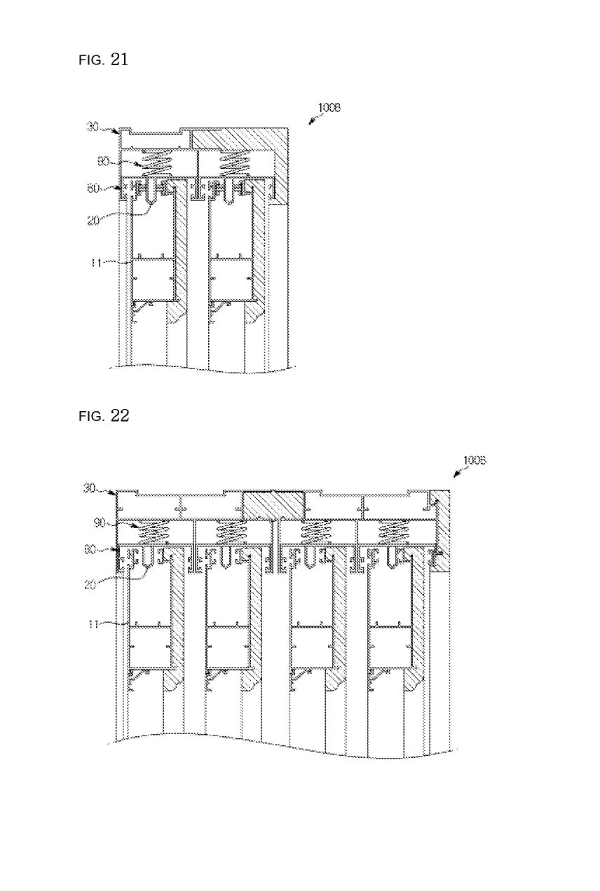

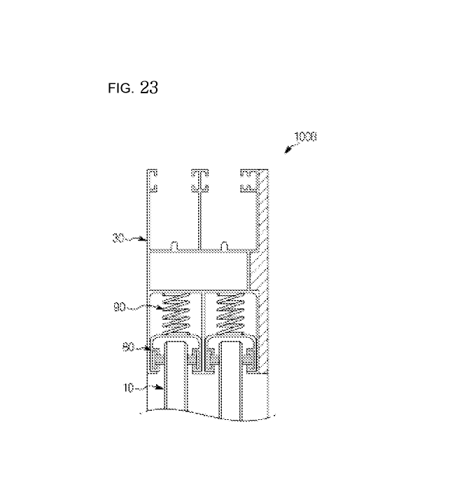

As illustrated in FIGS. 21 to 23, an air shield window of the present invention includes an upper frame of a window sash 70 which is installed by using a square frame of upper, lower, left, and right frames 30, 40, 50 and 60 where a rail 20 is formed where a window 10 having a window frame, which is opened and closed in a sliding manner, is moved.

At this time, the upper frame 30 has a square C-shape with an open bottom, and has an installation end 31 tightly contacting an installation part 201 of a building 200 and bent ends 32 which extend downwardly from both ends of the installation end and which are bent inwardly so as to face each other.

Further, stopper ends 81, which are disposed on the bent ends 32 of the upper frame 30, are formed at both ends, and a plurality of movable frames 80 of a square C-shape with an open bottom, which are composed of a plurality of rails 20, are formed on the lower part of the body end 82 to form a fitting frame 100B.

Further, stopper ends 81, which are disposed on the bent ends 32 of the upper frame 30, are formed at both ends, and a plurality of movable frames 80 of a square C-shape with an open bottom, which are composed of a plurality of rails 20, may be formed on the lower part of the body end 82.

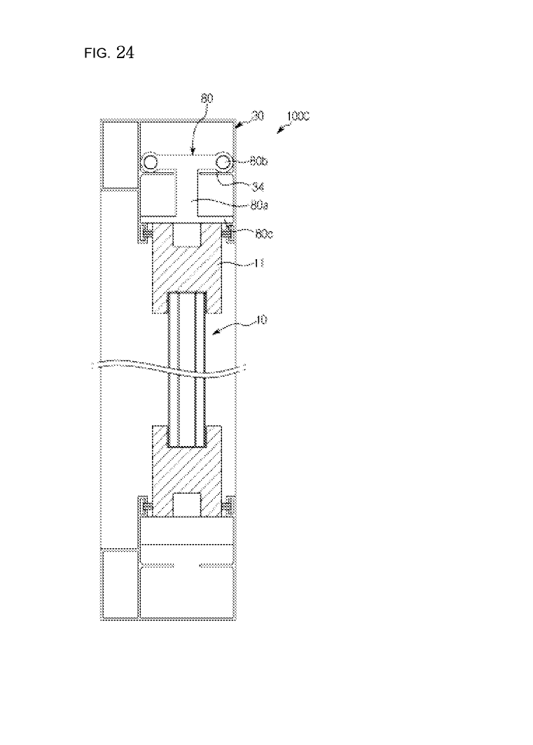

As illustrated in FIG. 24, an air shield window of the present invention includes an upper frame of a window sash 70 which is installed by using a square frame of upper, lower, left, and right frames 30, 40, 50 and 60 where a rail 20 is formed where a window 10 having a window frame 11, which is opened and closed in a sliding manner, is moved.

Here, the upper frame 30 has a square C-shape with an open bottom, and has an installation end 31 tightly contacting an installation part 201 of a building 200 and bent ends 32 which extend downwardly from both ends of the installation end and which are bent inwardly so as to face each other.

At this time, a middle end 34, which connects the inner surface of the installation end 31 and in which a penetration hole 34a is formed in the center, is provided.

Further, the movable frame 80, in which the upper stopper end 80a that is lifted on the middle end 34 and the lower stopper end 80b that is lifted on the bent end 32 are integrally formed, is formed on the upper and the lower end of the connection end 80a which is inserted into the penetration hole 34a of the upper frame 30, so as to form a fitting frame 100B.

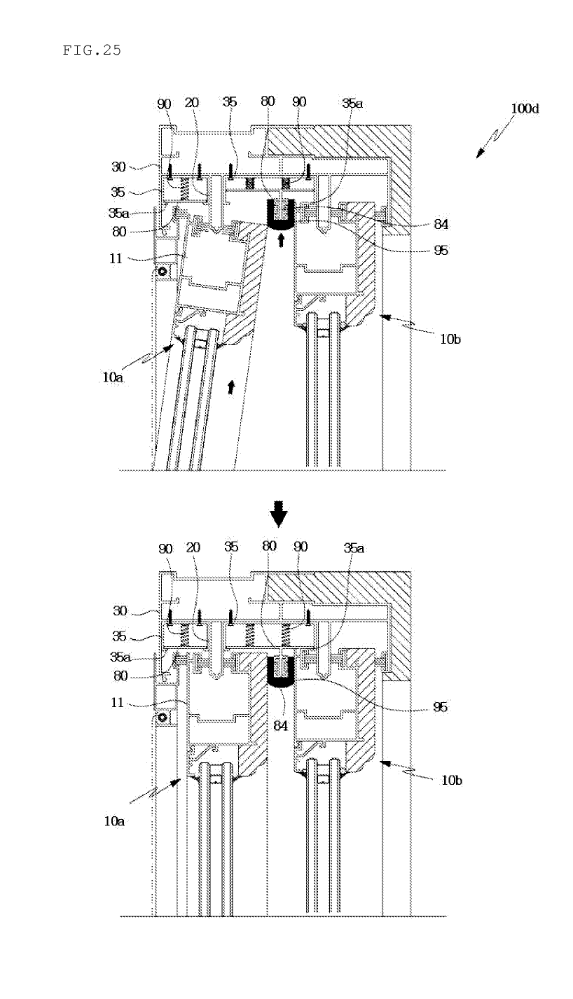

As illustrated in FIG. 25, as another example, the window 10 may include an external window 10a and an internal window 10b, and a fitting frame 100d, where a sealing part 95 is applied to seal the gap between the external window 10a and the internal window 10b, is provided.

In the fitting frame 100d, the fixed frames 35 having a fixed stopping part 35a, whose both ends are internally bent, are respectively inserted into a space between the upper frame 30 and the rail 20 and a space between the rail and the rail, and then are coupled with the lower part of the upper frame 30 by a screw nail. That is, the fixed frames are respectively inserted into a space between the upper frame 30 and the rail 20 and a space between the rail and the rail, and then are coupled with the lower part of the upper frame 30 by a screw nail, and the frames 35 are formed in a “ [symbol] ” shape where the bent fixing parts 35a are formed at both ends.

A pair of rails 20 are installed at the position which is opened to the lower part of the upper frame 30. Further, the movable frame 80 is caught in the fixed stopping part as the division end 84 is inserted into the internal part of the fixed frame 35 which is inserted into a space between the rail 20 and the rail 20. The shape of the cross-section of the sealing part 95 is formed in a square C-shape with an open bottom, and projections, which are inserted into the guide groove 85 of the division end, are formed to face each other at the internal walls which are facing each other. Further, the length of the sealing part 95 may be freely adjusted, and the central part is projected more than both ends.

Further, the movable frame 80, with which the sealing part 95 is not coupled, is caught in the stopping part 35a as it is inserted into the internal side of the fixed frame 35 which is coupled in a space between the upper frame 30 and the rail 20. Further, an elastic unit 90 is inserted into a space between the fixed frame 35 and the movable frame 80.

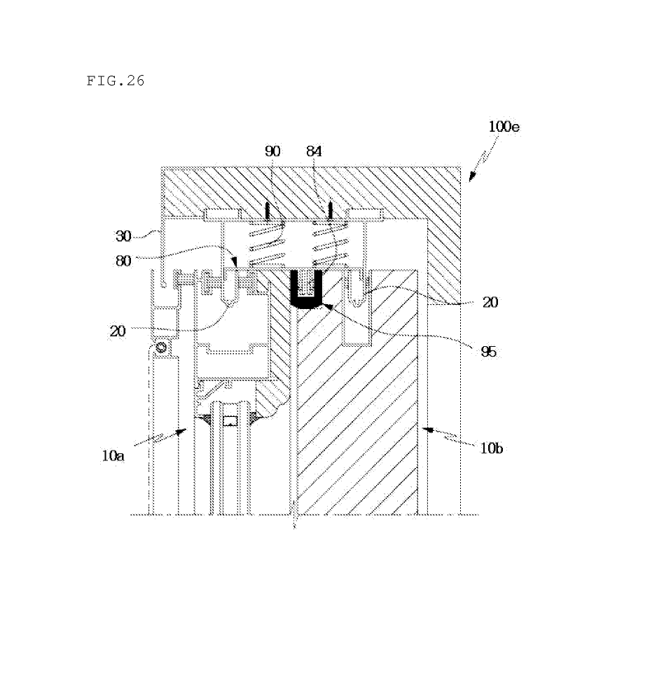

As illustrated in FIG. 26, as another example, the window 10 may include an external window 10a and an internal window 10b, and a fitting frame 100e, where a sealing part 95 is applied to seal the gap between the external window 10a and the internal window 10b, is provided.

The upper frame 30 is formed in a square C-shape with an open bottom, and a pair of “U”-type rails 20 are separately installed at lower side. Further, the movable frame 80 is inserted into the inside of the upper frame 30, and both ends of a square C-shape with an open bottom are inserted into the inside of the rail 20, and the division end 84, which is coupled with the sealing part 95, is projected downwards at the central part of the lower side of the both ends.

At this time, the elastic unit 90 is connected to the upper frame 30 in a manner that the elastic unit 90 is inserted into a space between movable frames 80 which are coupled with the upper frame 30 in a sliding manner.

The operation of the above configuration of the present invention will be described below.

As illustrated in FIGS. 5 to 7, a window 10 having a window frame 11 is installed as follows.

First, the movable frame 80 is inserted into the inside of the upper frame 30 and the stopper end 81 is disposed on the bent end 32 so as to complete the upper frame.

Thereafter, the upper frame 30 and the lower, left, and right frames 40, 50, and 60 are connected and coupled in a square frame form, and the coupled form is fixed on the installation unit 201 of the building so as to complete the construction of the window sash 70.

Thereafter, after the construction of the window sash 70 is completed, generally, in order to install the window 10, the upper end of the window 10 is inserted into the inner side of the upper frame 30 of the window sash 70 so that the lower end of the window 10 is placed on the upper part of the lower frame 40.

As such, in order to install the window on the window sash 70, the height of the inner space of the upper frame 30 of the window sash 70 need to be sufficiently high.

That is, when the window having a window frame 11 is installed at the window sash 70, the window 10 is installed at the inside of the upper frame 30 so that a vertical movement is possible, and when the window 10 is installed, the upper end of the window 10 pushes up the movable frame 80 so that the window is installed inside the window sash, thereby securing a margin space and lifting the lower end to the lower frame 40.

At this time, as the rail 20 is inserted into the rail groove 11a which is formed at the window frame 11 of the window 10, the movable frame 80 is pushed to the upper side.

Further, if the window 10 is installed, the movable frame 80 is moved to the lower part by the self-gravity, and the rail 20 is inserted into the inner side of the rail groove 11a to block a flow between the indoor area and the outdoor area so as to increase thermal insulation and prevent noise.

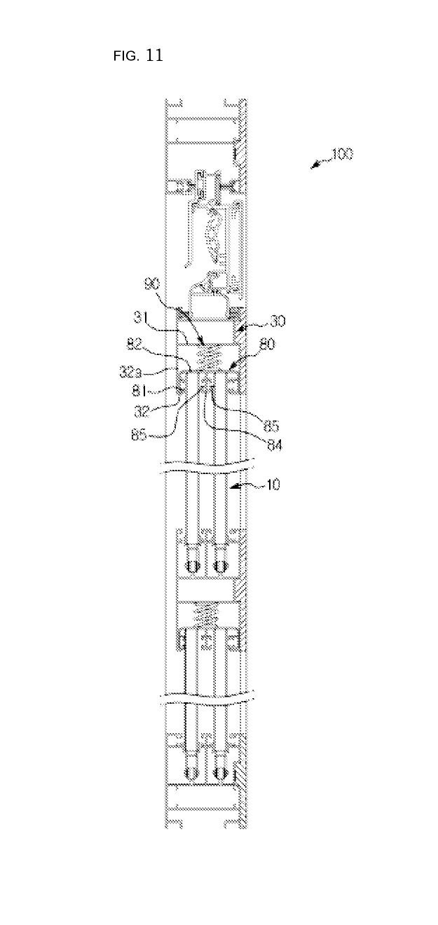

As illustrated in FIGS. 11 to 13, in order to install a window 10 without a window frame 10,

First, the construction method of the window sash 70 is the same as the method of installing the window having a window frame 11, and the window 10 without a window frame is also installed at the window sash in the same manner.

That is, in the present invention, when the window 10 without a window frame 11 is installed at the window sash 70, the window is installed at the inner side of the upper frame 30 so that a vertical movement is possible, and when the window 10 is installed, the upper end of the window 10 pushes up the movable frame 80 so that the window 10 is installed at the inner side of the window sash 70, thereby securing a margin space and lifting the lower end to the lower frame 40.

At this time, the window 10 is inserted into the internal side of the guide groove 85 which is formed at the window frame of the window 10 so as to push the movable frame 80 to the upper part.

Further, if the window 10 is installed, the movable frame 80 is moved to the lower part by the self-gravity, and the upper end of the window 10 without a window frame 11 is inserted into the inner side of the guide groove 85 so as to block a flow between the indoor are and the outdoor area, thereby increasing thermal insulation and blocking noise.

Commonly, when an elastic unit 90 is installed at a space between the upper frame 30 and the movable frame 80, the elastic unit 90 receives pressure by the movable frame 80, which is moved to the upper part by the push force, and is compressed, and then, if the window 10 is lifted to the lower frame 40, when the window 10 is moved to the lower part, the elastic unit 90 is restored so that the movable frame is moved to the lower part to be closely attached to the upper end of the window 10.

That is, the movable frame 80 is quickly moved to the lower part due to the elastic repulsing force of the elastic unit 90 to return to the original position, and the stopper end 81 is disposed at the bent end 32 of the upper frame 30 so that the movable frame 80 cannot move to the lower part any more, and, at the same time, pressure is not applied to the window frame 11 at the upper part of the window, or the upper end.

As illustrated in FIGS. 16 to 19, the operation of the fitting frame 100A, which is connected by the shaft-screw 87 and the nut 88, while the movable frame 80 is not disposed on the upper frame 30, is as follows.

First, the movable frame 80 is connected by the shaft-screw 87 and the nut 88 by closely attaching the movable frame 80 on the lower part of the upper frame 30.

Thereafter, after connecting left and right frames 40 and 50, which are connected to the lower frame 60, to both ends of the upper frame 30, the window 10 is installed.

Thereafter, the upper end of the window 10 pushes up the movable frame 80 so that a margin space for installing the window 10 at the window sash 70 is secured and the lower end is pushed up to the lower frame 40.

As illustrated in FIGS. 21 to 23, the movable frame 80 is inserted into the inner side of the upper frame 30 so that the stopper end 81 is disposed on the bent end 32.

That is, left and right frames 40 and 50, which are connected to the lower frame 60), are connected to both sides of the upper frame 30, and then the window 10 is installed.

At this time, the upper end of the window 10 pushes up the movable frame 80 without intervention of the movable frame 80 of the neighboring window 10 so that a margin space for installing the window 10 in the window sash 70 is secured, and the lower end is lifted up to the lower frame 40.

As such, if the window 10 is installed, the movable frame 80 is closely attached to the lower part so as to block a flow between the indoor area and the outdoor area.

The interference phenomenon does not occur as the movable frame 80 is vertically moved independently from the neighboring movable frame 80 with which the window 10 is coupled.

As illustrated in FIG. 24, the movable frame 80 is inserted into the upper frame 30 so that the upper and lower stopper ends 80a and 80b are disposed on the middle end 34 and the bent end 32.

Further, when installing the window 10 after connecting left and right frames 40 and 50, which are connected to the lower frame 60, to both sides of the upper frame 30, the upper end of the window 10 pushes up the movable frame 80 so that a margin space for installing the window 10 inside the window sash 70, and the lower end is pushed up to the lower frame 40.

Further, if the window 10 is installed, the movable frame 80 is moved and is closely attached to the lower part by the self-gravity so as to block a flow between the indoor area and the outdoor area.

At this time, if the movable frame 80 is pushed up to the upper part by the window 10, the movable frame 80 is moved to the upper part along the shaft-screw 87 or is moved to the upper part along with the shaft-screw 87, and is not separated to the lower part by the nut which is coupled to the upper frame 30 and the shaft-screw 87.

Likewise, if the window 10 is installed, the movable frame 80 is moved down and is closely attached to the lower part by the self-gravity so as to block a flow between the indoor area and the outdoor area.

That is, if the installation of the window 10 is completed by the self-gravity, the movable frame 80 is moved to the lower part, but the movable frame 80 may be pushed by the elastic force of the elastic member 90 to quickly return to the lower part.

As illustrated in FIG. 25, when the external window 10a or the internal window 10b are installed at the window sash 70, the upper part of the external window 10a or the internal window 10b is inserted into the window sash 70, and at this time, when the sealing part 95 contacts the external window 10a or the internal window 10b, the movable frame 80 is pushed upward, and the sealing part 95 and the movable frame 80 are pushed upward as the movable 80 pressures the elastic unit 90.

Thereafter, if the installation of the external window 10a or the internal window 10b is completed, the movable frame 80 is pushed down by the restoring force of the elastic unit 90 so that the sealing part 95 is returned to the original position. Further, both sides of the sealing part 95 are closely attached to the frame of the external window 10a or the internal window 10b, and thus the internal and external air circulation to the gab between the window frame 70 and the external window 10a or the internal window 10b is prevented. Further, the movable frame 80, which is not coupled with the sealing part 95, is not closely attached to the upper end of the window frame 11, thereby enabling double blocking.

As illustrated in FIG. 26, when the external window 10a or the internal window 10b are installed at the window frame 70, the upper end of the external window 10a or the internal window 10b is first inserted into the window frame 70, and at this time, when the external window 10a or the internal window 10b contacts the sealing part 95, the movable frame 80 is pushed up, and the sealing unit 95 and the movable frame 80 are pushed up while pressuring the elastic unit 90.

Thereafter, if the installation of the external window 10a or the internal window 10b is completed, the movable frame 80 is pushed down by the restoring force of the elastic unit 90 so that the sealing part 95 is returned to the original position. Further, both sides of the sealing part 95 are closely attached to the frame of the external window 10a or the internal window 10b, and thus the internal and external air circulation to the gab between the window frame 70 and the external window 10a or the internal window 10b is prevented.

While one or more embodiments of the present invention have been described with reference to the figures, it will be understood by those of ordinary skill in the art that various changes in form and details may be made therein without departing from the spirit and scope of the present invention as defined by the following claims.

1. An air shield window comprising: an upper frame of a window sash 70 which is installed by using a square frame of upper, lower, left, and right frames 30, 40, 50 and 60 where a plurality of rails 20 are formed where a window 10 having a window frame, which is opened and closed in a sliding manner, is moved, wherein the upper frame 30 has a square C-shape with an open bottom, and has an installation end 31 tightly contacting an installation part 201 of a building 200 and bent ends 32 which extend downwardly from both ends of the installation end and which are bent inwardly so as to face each other, wherein stopper ends 81, which are disposed on the bent ends 32 of the upper frame 30, are formed at both ends, and a plurality of movable frames 80 of a square C-shape with an open bottom, which are composed of a plurality of rails 20, are formed on the lower part of the body end 82, wherein, when installing the window 10 after connecting left and right frames 40 and 50, which are connected to the lower frame 60, to both sides of the upper frame 30 by disposing the stopper end 81 at the bent end 32 by inserting the movable frame 80 into the inner side of the upper frame, the upper end of the window 10 is pushed up to the lower frame 40 while securing a margin space for installing the window at a window sash 70, and wherein, if the window is installed, the movable frame 80 is moved down by the self-gravity to block a flow between an indoor area and an outdoor area.

2. The air shield window of claim 1, wherein, by inserting an elastic unit 90 into a space between the upper frame 30 and the movable frame 80, the elastic unit 90 is configured to be pressured by the movable frame 80, which is supported on the upper frame and is pushed up when the window 10 installed, and then to return the movable frame 80 to the lower part by the elastic force when the installation of the window 10 is completed.

3. The air shield window of claim 2, wherein the elastic unit 90 is formed in a semi-cylindrical shape, and both ends are freely supported or one end is fixed on the upper frame 30.

4. The air shield window of claim 2, wherein the elastic unit 90 comprises a coil spring or a conical coil spring having the same diameter of both ends.

5. An air shield window comprising: an upper frame 30 of a window sash 70 which is installed by using a square frame of upper, lower, left, and right frames 30, 40, 50 and 60 where a window 10 having a window frame, which is opened and closed in a sliding manner, is moved, wherein the upper frame 30 has a square C-shape with an open bottom, and has an installation end 31 tightly contacting an installation part 201 of a building 200 and bent ends 32 which extend downwardly from both ends of the installation end and which are bent inwardly so as to face each other, wherein the bent ends 32 are formed at lower ends of the extended ends 32a which are integrally extended in a lower direction of the lower surface of both ends of installation end, wherein stopper ends 81, which are disposed on the bent ends 32 of the upper frame 30, are formed at both ends, wherein the division ends 84 are formed under the central part of the body ends 82 which connect the stopper ends 81, and the movable frame 80 is formed in a square C-shape with an open bottom, and is composed of a plurality of guide grooves 85 between the stopper ends 81 and the division ends 84, wherein, when installing the window 10 after connecting left and right frames 40 and 50, which are connected to the lower frame 60, to both sides of the upper frame 30 by disposing the stopper end 81 at the bent end 32 by inserting the movable frame 80 into the inner side of the upper frame, the upper end of the window 10 is pushed up to the lower frame 40 while securing a margin space for installing the window at a window sash 70, and wherein, if the window is installed, the movable frame 80 is moved down by the self-gravity to block a flow between an indoor area and an outdoor area.

6. The air shield window of claim 5, wherein, by inserting an elastic unit 90 into a space between the upper frame 30 and the movable frame 80, the elastic unit 90 is configured to be pressured by the movable frame 80, which is supported on the upper frame and is pushed up when the window 10 installed, and then to return the movable frame 80 to the lower part by the elastic force when the installation of the window 10 is completed.

7. The air shield window of claim 6, wherein the elastic unit 90 is formed in a semi-cylindrical shape, and both ends are freely supported or one end is fixed on the upper frame 30.

8. The air shield window of claim 6, wherein the elastic unit 90 comprises a coil spring or a conical coil spring having the same diameter of both ends.

9. The air shield window of claim 8, wherein the elastic unit 90 is formed of the coil spring, and one end is fixed on the upper frame 30 or the movable frame 80 to prevent movement of the elastic unit 80.

10. An air shield window comprising: an upper frame of a window sash 70 which is installed by using a square frame of upper, lower, left, and right frames 30, 40, 50 and 60 where a rail 20 is formed where a window 10 having a window frame, which is opened and closed in a sliding manner, is moved, wherein the upper frame 30 has a square C-shape with an open bottom, and has an installation end 31 tightly contacting an installation part 201 of a building 200 and bent ends 32 which extend downwardly from both ends of the installation end and which are bent inwardly so as to face each other, wherein the upper frame 30 forms an upper hole 33 at both ends of the installation end 31 which contacts the installation unit 201 of the building 200 in a square C-shape with an open bottom, wherein the upper frame 20 is closely attached to the lower part of the installation end 31, and the movable hole 86 penetrates the body end 82 on the same line as that of the upper hole 33, wherein the movable frame 80 in a square C-shape with an open bottom, which is formed of a plurality of rails 20, is formed on the lower surface of the body end 82, wherein the nuts 88 are coupled with the shaft-screws 87 whose ends respectively penetrate the upper hole 33 of the upper frame 30 and the movable hole 86 of the movable frame 80, wherein the movable frame 80 is closely attached to the lower part of the upper frame 30 to be connected by the shaft-screws 87 and nuts 88, and wherein, when installing the window 10 after connecting left and right frames 40 and 50, which are connected to the lower frame 60, to both sides of the upper frame 30, the upper end of the window 10 is pushed up to the lower frame 40 while securing a margin space for installing the window at a window sash 70, and wherein, if the window is installed, the movable frame 80 is moved down by the self-gravity to block a flow between an indoor area and an outdoor area.

11. The air shield window of claim 10, wherein, by inserting an elastic unit 90 into a space between the upper frame 30 and the movable frame 80, the elastic unit 90 is configured to be pressured by the movable frame 80, which is supported on the upper frame and is pushed up when the window 10 installed, and then to return the movable frame 80 to the lower part by the elastic force when the installation of the window 10 is completed.

12. The air shield window of claim 11, wherein the elastic unit 90 is formed of sponge.

13. The air shield window of claim 10, wherein the elastic unit 90, which is inserted in a space between the upper frame 30 and the movable frame 80, is formed as a coil spring, the upper end of the spring is attached on the upper surface of the upper frame, and the lower end of the spring is formed on the roof surface of the movable frame 80.

14. An air shield window comprising: an upper frame of a window sash 70 which is installed by using a square frame of upper, lower, left, and right frames 30, 40, 50 and 60 where a rail 20 is formed where a window 10 having a window frame, which is opened and closed in a sliding manner, is moved, wherein the upper frame 30 has a square C-shape with an open bottom, and has an installation end 31 tightly contacting an installation part 201 of a building 200 and bent ends 32 which extend downwardly from both ends of the installation end and which are bent inwardly so as to face each other, wherein stopper ends 81, which are disposed on the bent ends 32 of the upper frame 30, are formed at both ends, and a plurality of movable frames 80 of a square C-shape with an open bottom, which are composed of a plurality of rails 20, are formed on the lower part of the body end 82, wherein, when installing the window 10 after connecting left and right frames 40 and 50, which are connected to the lower frame 60, to both sides of the upper frame 30 by disposing the stopper end 81 at the bent end 32 by inserting the movable frame 80 into the inner side of the upper frame 30, the upper end of the window 10 pushes up the movable frame 80 without intervention of the movable frame 80 of the neighboring window 10 so that a margin space for installing the window 10 in the window sash 70 is secured, and the lower end is lifted up to the lower frame 40, and wherein, if the window 10 is installed, the movable frame 80 is closely attached to the lower part so as to block a flow between the indoor area and the outdoor area.

15. The air shield window of claim 14, wherein stopper ends 81, which are disposed on the bent ends 32 of the upper frame 30, are formed at both ends, and a plurality of movable frames 80 of a square C-shape with an open bottom, in which one groove 20 is formed on the lower part of the body end 82 which connects the stopper ends 81, are provided.

16. An air shield window comprising: an upper frame 30 of a window sash 70 which is installed by using a square frame of upper, lower, left, and right frames 30, 40, 50 and 60 where a window 10 having a window frame, which is opened and closed in a sliding manner, is moved, wherein the upper frame 30 has a square C-shape with an open bottom, and has an installation end 31 tightly contacting an installation part 201 of a building 200 and bent ends 32 which extend downwardly from both ends of the installation end and which are bent inwardly so as to face each other, wherein a middle end 34, which connects the inner surface of the installation end 31 and in which a penetration hole 34a is formed in the center, is provided, wherein the movable frame 80, in which the upper stopper end 80a that is lifted on the middle end 34 and the lower stopper end 80b that is lifted on the bent end are integrally formed, is formed on the upper and the lower end of the connection end 80a which is inserted into the penetration hole 34a of the upper frame 30, wherein, when installing the window 10 after connecting left and right frames 40 and 50, which are connected to the lower frame 60, to both ends of the upper frame 30, by disposing upper and lower stopper ends 80a and 80b on the middle end 34 and the bent end 32 by inserting the movable frame 80 into the inner side of the upper frame 30, the upper end of the window 10 is pushed up to the lower frame 40 while securing a margin space for installing the window at a window sash 70, and wherein, if the window is installed, the movable frame 80 is moved down by the self-gravity to block a flow between an indoor area and an outdoor area.
